(19) United States
(12) Patent Application Publication
(10) Pub. No.: US 2021/0077875 A1
(43) Pub. Date: Mar. 18, 2021

(54) Device for Repairing Golf Ball Marks

(71) Applicant: FIXFORK OY, Kello (FI)

(72) Inventor: Jouko KOMULAINEN, Kello (FI)

(21) Appl. No.: 17/046,309

(22) PCT Filed: Apr. 11, 2019
(86) PCT No.: PCT/FI2019/000005

§ 371 Date: Oct. 9, 2020

(30) Foreign Application Priority Data
Apr. 12, 2018 (FI) 20187054

(51) Int. Cl. A63B 57/50

(52) U.S. Cl. CPC A63B 57/50; A63B 2102/32

(57) ABSTRACT

The present disclosure is directed to a device for repairing golf ball marks. The device includes a pin, a base and three or more prongs which are fixed to the base and extend in an opposite direction to the pin. The tips of the prongs are sloped. The inner sides of the prongs form a round shape in such a way that the inner edge of the slope part is a sharp protuberance. This protuberance is found at the thickest part of the prong. The device is pushed into the soil in such a way that the prongs surround the ball-mark. The inner sides of the prongs shift soil towards the centre of the ball-mark and the protuberance loosens the soil when the device is inserted into the soil. After that the soil is tamped down with, for example, a golf club to even out the putting surface.

### CROSS REFERENCE TO RELATED APPLICATIONS

This application is a national phase of International Application No.: PCT/FI2019/000005, filed on 11 Apr. 2019, which claims priority to Finnish Patent Application 20187054 filed on 12 Apr. 2018. The contents of the above-references applications are expressly incorporated herein by reference to their entireties.

### FIELD OF THE PRESENT DISCLOSURE

The present disclosure relates to a device for repairing golf ball marks, the device comprising a pin, a base and three or more prongs, and the base has a first surface, a second surface and an edge of the base, the pin is fixed to a central area on the first surface and the pin is configured to be inserted into a vent hole in the grip of a golf club and the pin defines the longitudinal axis of the device, and the prongs are fixed to the base and the prongs extend in an opposite direction to the pin or deviates at maximum 10 degrees, and there is a second surface level, which is a horizontal level on the second surface at the longitudinal axis.

### BACKGROUND

In the game of golf, it is common for the golf ball to land on the putting surface (a.k.a. the green) with sufficient force to leave an indentation or a ball-mark. It is proper golf etiquette for players to repair any ball-marks left by their golf ball on the putting surface, but many either fail to do so or compound the problem by using improper tools and/or techniques. Therefore, it is necessary for greenskeepers and their staff to professionally repair every green at regular intervals, such as once a day, because unrepaired or improperly repaired ball-marks can divert a putt. As a further complication, if the ball-mark repair is neglected for more than 24 hours, the damaged grass will die, leaving an unsightly brown spot and an uneven putting surface.

Specifically, ball-marks occur because players attempt to land their ball on the green during play. Ball-marks are basically indentations in the surface of a golf course putting area resulting from the ball landing on the golf course putting area with sufficient force to compress the turf, soil, and/or drainage material proximate to the impact location.

Several conventional devices exist for repairing ball-marks, including tools with extending blades mounted on a shaft. When operated, their blade tips move radially inward, dislodging the turf and soil from around the ball-mark and pushing the dislodged material towards the ball mark, levelling the indentation on the golf green. Such devices tend to displace, cut or tear through the turf and soil, repositioning a plurality of small areas of turf and soil inward, towards the ball-mark centre. Moreover, these devices are unable to reposition the raised mound since their blades uniformly reposition small areas of turf and soil around the edge of the ball-mark. One example of such a device is disclosed in the patent publication U.S. Pat. No. 6,048,274. The device is attachable to the end of a golf club. Patent publication U.S. Pat. No. 5,423,543 describes a similar device. This device can also be used for picking up golf balls. However, the user of these devices must be careful not to damage the grass roots. Patent publication U.S. Pat. No. 7,559,849 also discloses a device for repairing ball-marks that is attachable to the end of a golf club. The device comprises a multitude of tapered tines for loosening the soil under a ball-mark. These tines only loosen the soil and after using the device the user must move soil material and then flatten it with an additional tool which could be, for example, the head of a golf club. Patent publication U.S. Pat. No. 6,244,356 discloses a similar device. All of the aforementioned devices suffer from certain disadvantages, including that they could be used to repair ball-marks incorrectly, which means that the ball-marks take much longer to clear than those repaired properly.

### FIELD OF THE INVENTION

An object of the present disclosure is a solution that can significantly reduce the disadvantages and drawbacks of the prior art. In particular, the object of the present disclosure is a solution where a device is provided that fixes ball-marks and guides the user to manipulate the device correctly.

It has been determined that many golfers use ball-mark repair tools incorrectly. They insert the tool at an angle, so that the prongs go under the center of the ball-mark and then use the tool as a lever to lift the bottom of the ball-mark up so that it is even with the surface again. Lifting the bottom of the depression upwards tears off the roots, killing the grass. Also, the prongs should not be inserted into the ball-mark depression itself, but at the rim of the ball-mark. Inserting the prongs into the ball-mark only pushes the packed soil in deeper.

The present disclosure is directed to a device comprising a pin, a base and three or more prongs which are fixed to the base and extend in an opposite direction to the pin. The tips of the prongs are sloped in such a way that the sharp part of the tip is on the outer side of the prong, i.e. the tip is wedge-like and its thickness increases towards the centre of the device. After the slope part, the inner sides of the prongs form a round shape in such a way that at the inner edge of the slope part there is a sharp protuberance. This protuberance is locally the thickest part of the prong, i.e. the prong is thinner around the protuberance. The device is pushed into the soil in such a way that the prongs surround the ball-mark. The curved parts on the inner sides of the prongs shift the soil towards the centre of the ball-mark and the protuberance loosens the soil when the device is inserted into the soil. When the device is lifted, the protuberance moves some of the soil upwards and shifts it towards the centre of the ball-mark. After that the soil under the ball-mark is tamped down with, for example, a golf club to even out the putting surface.

When reference is made in the text to the upper or the lower parts or respective directions such as down or up, a situation is described in which the device according to the present disclosure is resting on a surface in such a way that the tips of the prongs are on the surface. Also, when reference is made to the vertical or horizontal directions or surfaces, the device is placed similarly.

In one embodiment of the present disclosure, a device for repairing golf ball marks is set out, the device comprising a pin, a base and three or more prongs. The base has a first surface, a second surface and an edge of the base. The pin is fixed on a central area on the first surface and the pin is configured to be inserted at least into a vent hole in the grip of a golf club. The device has a longitudinal axis, and the pin defines the said longitudinal axis, i.e. the longitudinal axis of the device is congruent with the longitudinal axis of the pin, or deviates at a maximum of up to 10 degrees from the direction of the pin. The prongs are fixed to the base and the prongs extend in an opposite direction to the pin, and there is a second surface level which is a horizontal level on the second surface at the longitudinal axis. In one advantageous embodiment of the present disclosure, the prong is an elongated structure, and the prong comprises an outer side, an inner side and an end part. The inner side is facing towards the longitudinal axis of the device and the outer side is facing away from the longitudinal axis, and at the end part is a sloping section having a first edge and a second edge. The second edge is on the inner side, and the second edge is closer to the longitudinal axis and the second surface level than the first edge. There are parts on the prong between the second edge and the second surface level where the thickness of the prong, i.e. the horizontal distance between the outer side and the inner side, is smaller than the thickness of the prong at the second edge, and the distances of the tips of all the prongs from the longitudinal axis are greater than the radius of a golf ball. The shape of the prongs, and especially the shape of the inner sides of the prongs, facilitates shifting soil from the surrounding area of the ball-mark, and there is no need to twist or shake the device to achieve this effect. Also, there are no prongs in the middle area of the device.

In one embodiment of the device according to the present disclosure, the first edge and the second edge are horizontal.

In a second embodiment of the device according to the present disclosure, the length of the first edge is greater than the length of the second edge. This has been found to improve soil-moving because more soil is loosened.

In a third embodiment of the device according to the present disclosure, the vertical distance between the second surface level and the second edge is greater than the radius of a golf ball. This has been found to produce an optimal length for the prong.

In a fourth embodiment of the device according to the present disclosure, the first surface is flat. This feature keeps the device stationary when it is inserted into the vent hole in the grip of a golf club and is used to repair the ball-mark.

In a fifth embodiment of the device according to the present disclosure, the inner sides of the prongs between the second edge and second surface level follow at least partly the curvature of a golf ball. This produces prongs that shift soil efficiently. Also, it makes it possible to modify or use the device to carry or pick up a golf ball.

In a sixth embodiment of the device according to the present disclosure, the prongs are situated symmetrically in relation to the longitudinal axis. This is for shifting soil evenly.

In a seventh embodiment of the device according to the present disclosure, there are four prongs and each prong has a counterpart on the opposite side of the edge of the base.

In an eight embodiment of the device according to the present disclosure, there are six prongs and each prong has a counterpart on the opposite side of the edge of the base.

In a ninth embodiment of the device according to the present disclosure, the horizontal cross-section of the prong forms a quadrangle. This produces an efficient shape for the prong to shift soil.

In a tenth embodiment of the device according to the present disclosure, the outer side of the prong is at least partly vertical. This makes it easier to insert the prongs into the soil. Also, it guides the user to position the device correctly for repairing ball-marks.

In an eleventh embodiment of the device according to the present disclosure, there is a groove or grooves on the pin to keep it in the vent hole in the grip of a golf club.

In a twelfth embodiment of the device according to the present disclosure, the angle between the slope and a surface that is parallel to the second surface level is between 30 and 70 degrees.

In a thirteenth embodiment of the device according to the present disclosure, the first edges of the sloping sections of the prongs define a first circle and the second edges of the sloping sections of the prongs define a second circle, and the diameter of the first circle is larger than the diameter of a golf ball and the diameter of the second circle is smaller than the diameter of a golf ball.

In a fourteenth embodiment of the device according to the present disclosure, the prongs are configured to clamp a golf ball between them in such a way that the golf ball is attachable to the device and removable from the device. This means that the prongs should be at least partly elastic.

It is an advantage of the present disclosure that it provides a device that is easy to use for repairing golf ball marks on a golf course and especially on greens. Using the device significantly improves the results of golf ball mark repair. It also discourages incorrect repair technique. It also produces a device that is suitable for carrying and picking up golf balls.

An advantage of the present disclosure is that it is fast to use. In many cases enough soil is shifted to the centre of the ball-mark to repair it when the device is inserted once. The device can also be easily and quickly assembled and disassembled.

It is a further advantage of the present disclosure that it reduces the need to kneel and thus helps people with physical challenges.

It is a further advantage of the present disclosure that it is easily applicable to existing systems.

### BRIEF SUMMARY OF THE DRAWINGS

In the following, the present disclosure is described in detail. The description refers to the accompanying drawings, in which:

FIG. 1a depicts an example of a device in accordance with an embodiment of the present disclosure;

FIG. 1b depicts a side view of the device depicted in FIG. 1;

FIG. 1c depicts a cross section of the device depicted in FIG. 1; and

FIG. 2 depicts another example of a device according to an embodiment of the present disclosure.

### DETAILED DESCRIPTIONS

The embodiments in the following description are given as examples only and someone skilled in the art can carry out the basic idea of the present disclosure also in some other way than what is described in the description. Though the description may refer to a certain embodiment or embodiments in several places, this does not mean that the reference would be directed towards only one described embodiment or that the described characteristic would be usable only in one described embodiment. The individual characteristics of two or more embodiments may be combined and new embodiments of the present disclosure may thus be provided.

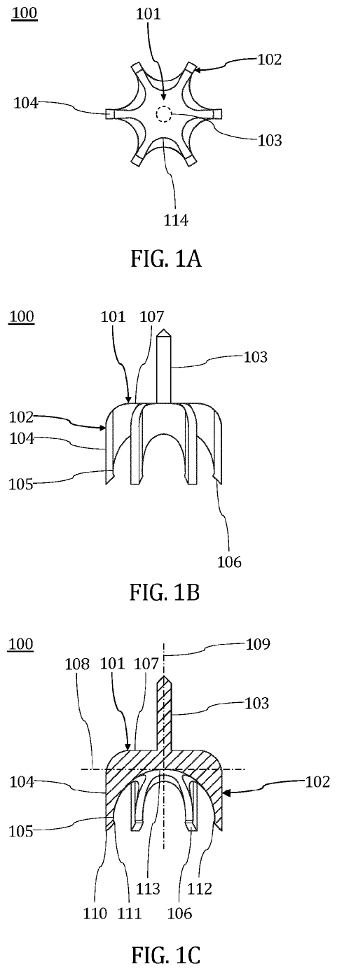

FIGS. 1a-1c depict an example of a device 100. The device comprises a base 101, a pin 103 and in this embodiment six prongs 102.

In FIG. 1a the device is seen from below. In FIG. 1b it is seen from the side and in FIG. 1c a cross-section of the device is shown.

The base 101 is, in this example, a flat body comprising a first surface 107, a second surface 113 and an edge 114 of the base. The pin 103 is an elongated structure. The pin is fixed to a central area on the first surface. The pin is configured to be inserted into a vent hole in the grip of a golf club. Naturally, this configuration also allows insertion of the pin into another body that could function as a grip. The body should have a hole or similar into or to which the pin could be inserted or attached. In some embodiments the pin has a groove or grooves or similar shapings. These shapings help to keep the pin in place when the pin is inserted into a body or a golf club. In some embodiments, the first surface is flat so as to improve the stationary position of the device when it is inserted into a body or a golf club. The horizontal level on the second surface at the longitudinal axis is a second surface level 108.

The device 100 has a longitudinal axis 109. The pin defines the longitudinal axis of the device. The axis (longitudinal) of the pin is congruent to the longitudinal axis of the device.

The prongs 102 are on the edge 114 of the base 101. In this example, the prongs are hook-like structures which extend first in a horizontal direction, away from the longitudinal axis 109 and then extend vertically. The prong comprises an upper part, an outer side 104, an inner side 105 and an end part. The upper part of the prong is fixed to the edge of the base. The inner side is facing towards the longitudinal axis of the device and the outer side is facing away from the longitudinal axis. There are embodiments where the prongs are fixed differently. What is essential is that they form a ring that is placeable around a ball-mark and there are no prongs inside this ring and the distances of the tips of all the prongs from the longitudinal axis is greater than the radius of a golf ball. The edge of the base could extend beyond this ring.

At the end part of the prong 102 is a sloping section 106, having a first edge 110, and a second edge 111. The first edge is a tip of the prong. The second edge is on the inner side 105. The sloping section forms at the end part of the prong a wedgelike structure and the thin part of the wedge is on the outer side 104. The second edge is closer to the longitudinal axis and the second surface level than the first edge. In an advantageous embodiment, the first edge and the second edge are horizontal, i.e. they are parallel to the second surface level 108. In some embodiments, the length of the first edge is greater than the length of the second edge. Also, there are embodiments where the horizontal cross-section of the prong is a quadrangle, i.e. there are four angles. These embodiments improve soil loosening and shifting. To improve insertion of the device 100 into the soil there are embodiments in which the outer side of the prong is at least partly vertical.

At the second edge 111 the prong 102 is thicker in the horizontal direction than the prong immediately above and below the second edge. This means that at the second edge is a protuberance 112 in the prong. Advantageously, the slope upwards, i.e. towards the second surface level 108, is steeper than the sloping section 106. This protuberance will open the hole for the prong and loosen the soil when it is inserted into the soil. The protuberance also lifts soil when the device is lifted from the soil.

In this example, there are six prongs 102 that are placed symmetrically in relation to the longitudinal axis 109. Each prong has a counterpart on the opposite side of the edge 114 of the base 101. The device can be implemented with three, four of five prongs. When using a device with less than six prongs, two or more insertions may be required to lift and loosen enough soil to repair a ball-mark. Using a device with more than six prongs may result in too much loose soil and/or damage to the grass roots. There are embodiments where only some of the prongs are shaped as was described before. The unshaped prongs could be straight sharp structures which are situated between the shaped prongs.

The upper parts of the inner sides 105 of the prongs 102 are curved towards the longitudinal axis 109. This means that the thickness of the prongs increases in the upper parts of the prongs. When inserting the device 100 into the soil, these thicker parts of the prongs push soil towards the centre of the ball-mark and thus improve the efficiency of the device. In some embodiments, between the prongs, the edge 114 of the base is curved and forms a sharp edge. The edge of the base between the prongs is closer to the level of the tips of the prongs than the second surface level 108, i.e. the vertical distance from the second surface level to the level of the tips of the prongs is longer than the distance of the edge of the base between the prongs to the level of the tips of the prongs.

When developing a device for repairing ball-marks it has been determined that the device 100 is also suitable for picking up and carrying golf balls. In an embodiment the prongs 102 can be configured to clamp a golf ball between them in such a way that the golf ball is attachable to the device and removable from the device. This means that the first edges of the sloping sections of the prongs define a first circle and the second edges of the sloping sections of the prongs define a second circle, and the diameter of the first circle is larger than the diameter of a golf ball and the diameter of the second circle is smaller than the diameter of a golf ball. Also, the prongs should be at least partly elastic. In one embodiment, the vertical distance between the second surface level and the second edge is bigger than the radius of a golf ball. Also, the inner sides 105 of the prongs between the second edge 111 and second surface level 108 follow at least partly the curvature of a golf ball. Because the device can be placed on the end of a golf club, the device can be an aid for golf players who have difficulty with kneeling. Such players can use the device for both repairing ball-marks and for picking up golf balls.

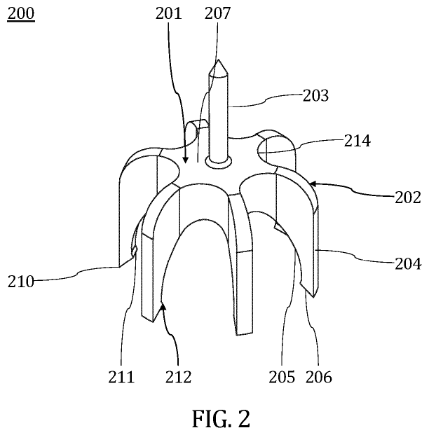

FIG. 2 depicts a second example of the device 200 according to an embodiment of the present disclosure. The device comprises a base 201, a pin 203 and in this embodiment six prongs 202. The base comprises a first surface 207, a second surface (not marked in the figure) and an edge 214 of the base.

The prong 202 comprises an upper part and an end part. The upper part of the prong is fixed to the edge 214. The prong also comprises an outer side 204 and an inner side 205. At the end part of the prong is a sloping section 206 having a first edge 210, and a second edge 211, both of which are horizontal. At the second edge is a protuberance 212 in the prong. The protuberance forms a thicker part in the end part of the prong.

In this embodiment the prongs 202 are manufactured separately and then attached to the body 201. There are embodiments where the body and the prongs are made in one piece. The material of the device 200 can be for example plastic, metal or some combination of different materials.

Some advantageous embodiments of the device according to the present disclosure have been described above. The present disclosure is however not limited to the embodiments described above, but the inventive idea can be applied in numerous ways within the scope of the claims.

1. A device for repairing golf ball marks, the device comprising a pin, a base and three or more prongs, and the base has a first surface, a second surface and an edge of the base, the pin is fixed on a central area on the first surface and the pin is configured to be inserted at least into a vent hole in the grip of a golf club, and the device has a longitudinal axis and the pin defines said longitudinal axis, and the prongs are fixed to the base and the prongs extend in an opposite direction to the pin or deviates at maximum 10 degrees, and there is a second surface level which is a horizontal level on the second surface at the longitudinal axis, and the prong is an elongated structure and the prong comprises an outer side, an inner side and an end part, and the inner side is facing towards the longitudinal axis of the device and the outer side is facing away from the longitudinal axis, and at the end part is a sloping section having a first edge, which is a tip of the prong, the device comprising the sloping section further having a second edge -and the second edge is on the inner side and the second edge is closer to the longitudinal axis and the second surface level than the first edge, and there are parts on the prong between the second edge and the second surface level where the thickness of the prong, the horizontal distance between the outer side and the inner side, is smaller than the thickness of the prong at the second edge, and the distances of the tips of all the prongs from the longitudinal axis is greater than the radius of a golf ball.

2. The device according to claim 1, wherein in that the first edge and the second edge are arranged horizontally.

3. The device according to claim 1, wherein a length of the first edge is greater than a length of the second edge.

4. The device according to claim 1, wherein vertical distances between the second surface level and the second edge is greater than the radius of a golf ball.

5. The device according to claim 1, wherein the first surface is flat.

6. The device according to claim 1, wherein the inner sides of the prongs between the second edge and second surface level follow a curvature of a golf ball.

7. The device according to claim 1, wherein the prongs are arranged symmetrically in relation to the longitudinal axis.

8. The device according to claim 1, further comprising four prongs wherein each prong has a counterpart on the opposite side of the edge of the base.

9. The device according to claim 1, further comprising six prongs wherein each prong has a counterpart on the opposite side of the edge of the base.

10. The device according to claim 1, wherein the horizontal cross-section of the prong is a quadrangle.

11. The device according to claim 1, wherein an outer side of the prong is at least partly vertical.

12. The device according to claim 1, further comprising a groove or grooves on the pin arranged to keep the pin in a vent hole in a grip of a golf club.

13. The device according to claim 1, wherein an angle between the sloping section and a surface that is parallel to the second surface level is between 30 and 70 degrees.

14. The device according to claim 1, wherein first edges of the sloping sections the prongs define a first circle and second edges of the sloping sections of the prongs define a second circle, and a diameter of the first circle is larger than a diameter of a golf ball and a diameter of the second circle is smaller than the diameter of a golf ball.

15. The device according to claim 1, wherein the prongs are configured to clamp a golf ball between them in such a way that the golf ball is attachable to the device and removable from the device.
